(19) United States
(12) Patent Application Publication
(10) Pub. No.: US 2010/0205168 A1
(43) Pub. Date: Aug. 12, 2010

(54) Thread-Based Incremental Web Forum Crawling

(75) Inventors: Jiangming Yang, Beijing (CN); Rui Cai, Beijing (CN); Lei Zhang, Beijing (CN); Wei-Ying Ma, Beijing (CN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/368,768

(22) Filed: Feb. 10, 2009

(51) Int. Cl. G06F 17/30

(52) U.S. Cl. 707/709; 707/E17.108

(57) ABSTRACT

The incremental web forum crawling technique described herein is a web forum crawling technique that employs a thread-wise strategy that takes into account thread-level statistics, for example, the number of replies and the frequency of replies, to estimate the activity trend of each thread. To extract such statistical information, the technique employs a simple yet very robust approach to extract the timestamp of each post in a discussion thread. It also employs a regression model to predict the time of the next post for each thread.

Due to the explosive growth of the World Wide Web, web forums (also called bulletins or discussion boards) are becoming important data resources, and many research efforts and commercial systems have begun to leverage information extracted from forum data to build various Web applications.

For most Web applications, the first step is to fetch data pages from various web sites distributed on the Internet. However, web forum crawling is not a trivial task and cannot be easily handled by using a generic web crawler. Compared to general websites, web forums have some unique characteristics. For example, every day a substantial number of discussion threads are created or frequently updated, while many discussion threads become inactive and are no longer changed. This is quite different from generic web pages which usually have static Uniform Resource Locator (URL) addresses and content. On a web forum a post is a user submitted message (typically enclosed in a block containing the user's details and the date and time it was submitted). Posts are contained in threads, where they typically appear as boxes one after another. The first post starts the thread. Posts that follow in the thread are meant to continue discussion about that post, or to respond to other replies.

Forum pages are often typically generated based upon pre-defined templates. As a result, the pages of a given forum site may be classified into several categories, in which each category represents a specific function. For example, generic forums usually have list-of-board pages, list-of-thread pages, post-of-thread pages, user profile pages, and so forth. List-of-board pages are sometimes seen on forum sites that are very large, where discussion threads may be divided into several sub-boards based on their topics. In this case, a list-of-board page will list all of the sub-board or sub-topic names. List-of-thread pages typically exist for each sub-board, where, for example, users' posts are organized with discussion threads—the posts in the same thread belong to the same topic. List-of-thread pages typically list the title of each thread in a forum site along with the last post for each thread. Post-of-thread pages exist for each discussion thread and list the posts belonging to a given thread. To extract post content, identification and classification of post-of-thread pages and list-of-thread pages is useful. Once classified, page classification may be used in forum page understanding, and for further analysis of forum data. Page classification is also valuable in forum crawling, e.g., page classification is a component used in recovering the structure of the forum site, and in determining an optimized route for a crawler.

To obtain new discussion threads a system should efficiently find new URLs of new discussion threads. This is important because many new problems and events are responded to quickly in forum sites. To update existing discussion threads a system should identify updated threads and re-crawl the newly added content efficiently.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The incremental web forum crawling technique described herein is a web forum crawling technique that employs a thread-wise strategy that takes into account thread-level statistics, for example, the number of replies and the frequency of replies, to estimate the activity trend of each thread of a web forum site. To extract such statistical information, the technique employs a simple yet very robust approach to extract the timestamp of each post in a discussion thread. It also employs a regression model to predict the time of the next post for each thread.

In the following description of embodiments of the disclosure, reference is made to the accompanying drawings which form a part hereof, and in which are shown, by way of illustration, specific embodiments in which the technique may be practiced. It is understood that other embodiments may be utilized and structural changes may be made without departing from the scope of the disclosure.

### DESCRIPTION OF THE DRAWINGS

The specific features, aspects, and advantages of the disclosure will become better understood with regard to the following description, appended claims, and accompanying drawings where:

FIG. 1 is an illustration of an exemplary forum sitemap.

FIG. 2 is a schematic of an overview of the components of one embodiment of the incremental web forum crawling technique.

FIG. 3 is an example of page flipping links of a web forum site.

FIG. 4 is a flow diagram depicting an exemplary embodiment of a process employing the incremental web forum crawling technique.

FIG. 5 is flow diagram depicting another exemplary embodiment of a process employing the incremental web forum crawling technique.

FIG. 6 is an exemplary system architecture in which one embodiment of the incremental web forum crawling technique can be practiced.

FIG. 7 is a schematic of an exemplary computing device which can be used to practice the incremental web forum crawling technique.

### DETAILED DESCRIPTION

In the following description of the incremental web forum crawling technique, reference is made to the accompanying drawings, which form a part thereof, and which show by way of illustration examples by which the incremental web forum crawling technique described herein may be practiced. It is to be understood that other embodiments may be utilized and structural changes may be made without departing from the scope of the claimed subject matter.

### 1.0 Incremental Web Forum Crawling Technique.

### 1.1 Overview of the Technique

The present incremental web forum crawling technique implements an incremental web crawling strategy to efficiently crawl web pages from any forum sites. Instead of treating each individual page independently, as is typically done in generic crawlers, the technique takes into account thread-level statistics in each discussion thread, for example, the number of replies, the frequency of replies, and the time stamp of each reply. Such information is then employed to execute an efficient re-crawl strategy.

To have a better understanding of user behaviors in a target forum site, the technique first reconstructs a sitemap of a given forum site by grouping forum pages according to their page layout similarities. With this automatically reconstructed sitemap, the technique then identifies page-flipping links which are purposely designed to help users to browse a long discussion thread (which lists user posts for a given thread title) that is divided into multiple pages. Thereafter, the technique analyzes each discussion thread as a whole by concatenating multiple pages belonging to this thread together. List-of-thread pages can also be processed similarly. (A list-of-thread page is a page that provides a list of discussion threads for the forum site.) To leverage such thread-level and site-level statistical information, in one embodiment, the technique reliably extracts the timestamp of each post in a discussion thread. Based on a simple observation that all the posts belonging to one thread are organized sequentially in multiple pages, the technique employs a simple yet very robust approach to finding the HTML pattern that timestamps are sorted in an ascendant or descendant order. The timestamp detection approach will be described in detail in the following sections. This approach enables the technique to estimate the activity trend of each thread. In case some threads are short in length and have limited information, the technique can leverage some site-level statistics, such as the average time interval between two consecutive posts, to estimate its approximate update frequency. Such kinds of information for both threads and the whole site have been analyzed and found to be linearly related to the time interval between two consecutive posts. To take into consideration all of these factors, the technique employs a regression model to predict the time of the next post. The technique then uses this information to determine when to re-crawl a given forum page.

Based on the model, the technique provides a highly efficient crawler which is much faster than state-of-the-art methods in terms of fetching the newly generated content, and can still ensure a higher coverage ratio. The incremental web forum crawling technique provides the following:

(a) Thread-Wise Estimation. The incremental web-crawling technique can automatically learn page relationships for a given forum site. By following the page-flipping links of each discussion thread or list-of-thread, the technique can concatenate multiple pages belonging to the same discussion thread (or list-of-thread) together and treat them as a whole. In this way, the technique can avoid repeatedly crawling existing posts and instead focus on newly updated content. The thread-level statistics are also very helpful for estimating the update frequency of each discussion thread.

(b) Regression Based Prediction Model. In web forum sites, much of the site-level information can be used to estimate the update frequency of an object (a discussion thread or posts of a thread) or a thread list (e.g., list-of-threads) and its longevity more accurately, such as the number of users, the “hotness”, or update frequency, of each discussion board, and users' historical behaviors. Based on the statistics for each discussion thread and the site-level information, in one embodiment, the technique employs a regression-based prediction model, which can effectively combine various statistics to predict the time interval between the last reply and the upcoming reply in a given discussion thread.

(c) Bandwidth Control. By treating a discussion thread as an entire post list, the technique can easily find the latest replies in each thread. Similarly, by understanding thread lists, the technique can discover new discussion threads efficiently. As the two types of pages (list-of-post pages and list-of-thread pages) play different roles in forums, in one embodiment, the incremental web forum crawling technique employs an efficient bandwidth control strategy for post and thread list pages to balance between discovering new content and refreshing existing content.

### 1.2 Background

There is little existing work in literature that has systemically investigated the problem of incremental forum crawling. However, there are some works that are useful to review to provide background information for understanding the present incremental web forum crawling technique.

One early work investigated the dynamic Web and treated information as a depreciating commodity. This work first introduced the concepts of lifetime and age of a page which is important for measuring the performance of an incremental crawler. However, this work treated every page equally and ignored importance and change frequency which are also important to an incremental crawler. Whether to minimize the age or to maximize the freshness leads to a variety of analytical models by employing different features. These can be classified into three categories:

How often the content of a page is updated by its owner. How often the content of a forum page is updated by its owner is one factor considered in measuring the performance of an incremental web crawler. Some studies of web crawling have proposed methods based on page update frequency. Most of these methods are based on the assumption that most web pages change as a Poisson or memoryless process. However, it has been shown that most web pages are modified during the span of U.S. working hours (between 8 AM and 8 PM, Eastern time, Monday to Friday). This phenomenon is even more evident in forum websites due to the fact that the content is primarily generated by forum users. Some studies have tried to use an adaptive approach to maintaining data on actual change rates for the optimization without the above assumption. However, they still treated each page independently and wasted bandwidth in crawling the same post which appears several times in other pages belonging to the same discussion thread. Furthermore, other factors, such as the time intervals for the latest several posts and the average time interval between two consecutive posts, are more important in web forums than how often the content of a page is updated by its owner.

The importance of each web page. Some researchers tried to determine the importance or weight of each page in a web forum site based on some strategies similar to the popular PageRank algorithm which ranks pages based on their relative importance. Others assigned the weight of each page based on an embarrassment metric of users' search results. In user-centric crawling, targets are mined from user queries to guide the refreshing schedule of a generic search engine. First of all, some pages may have equal importance weights but different update frequency, thus only measuring the importance of each web page is not enough. Second, both PageRank importance and content importance are useless in web forums. Most pages in web forums are dynamic pages which are generated using some pre-defined templates. It is very hard to compute their PageRank importance since there are medial links among these pages. Furthermore, the content importance measurement is also useless. Once a post is generated, this post always exists unless the user deletes it manually. But before obtaining post information, it is very hard to measure its importance or index quality through related search results. But once content importance information is obtained it is usually not necessary to revisit this information anymore. Some works have focused on crawling attempts to only retrieve web pages that are relevant to some pre-defined topics or some labeled examples by assigning pages similar to the target page a higher weight. The target descriptions in focused crawling are quite different in various applications.

The information longevity of each web page. One study of web crawling introduced a longevity factor to determine revisit frequency of each web page in web crawling. However, the information longevity in web forums is useless since once a post is generated, this post exists unless it is deleted manually. This is one of the major differences between general web pages and forum web pages.

All the existing methods discussed above lack consideration of the trade-offs between discovering new threads and keeping existing threads fresh. For example, discussion thread pages usually contain the most useful contents in web forums while list-of-thread pages contain fewer detailed contents. And a list-of-thread page usually gets lower update frequency than a post page which is affected by every posting activity. From all the above aspects, it seems that one should assign lower weights for list-of-thread pages when scheduling the crawling queue. In contrast, since one can only get new discussion threads from list-of-thread pages, one may get a very poor performance using the above strategy. Unfortunately, none of the above-discussed methods has taken this into account. .

### 1.3 Operating Environment/Definitions

The following paragraphs describe some of the concepts and terminology in which the present current incremental web forum crawling technique operates. This includes forum organization, list-of-thread pages and discussion threads (list-of-post pages).

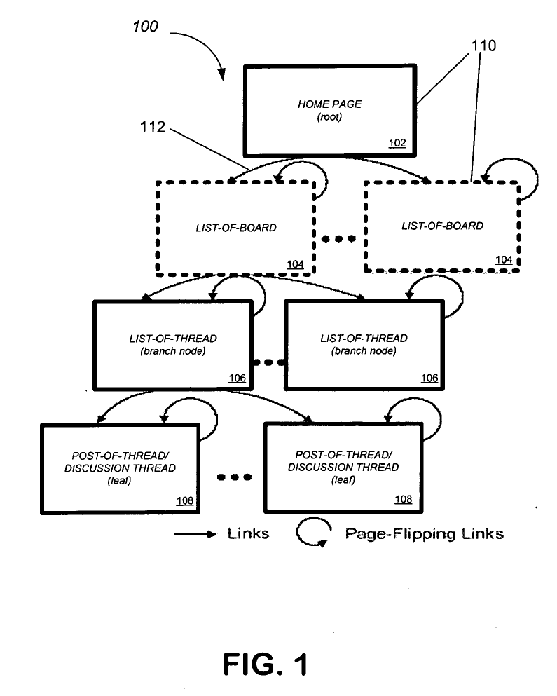

1.3.1 Forum Organization. For users' convenience, a well organized forum site consists of a tree like directory structure containing at the lowest end topics (commonly called threads) and inside of them posts. The messages within these most conventional forum sites are displayed in several sub-boards or sub-topics. FIG. 1 provides a sitemap 100 or an illustration of the organization from an exemplary ASP.NET forum. A sitemap is a directed graph consisting of a set of vertices and the corresponding links. The tree structure 100 contains a home page 102 at the top (root) level, followed by list-of-board pages 104 and list-of-thread or discussion thread pages 106. At the lowest level of the tree are leaf nodes which represent the list-of-post pages 108. Each vertex 110 of the tree represents a group of forum pages which have similar page layout structures; and each link 112 denotes a kind of linking relationships between two vertices. Different forum sites may have different organizations which can cause different tree levels. For example, the level of the tree for the ASP.NET site is four.

1.3.2 List-of-Board Pages. List-of-Board pages are typically only used in very large forum sites where discussion threads are divided into several sub-boards based on their topics. They list all of the sub-board names.

1.3.3 List-of-Thread Pages. Pages of the branch node in the tree are called list-of-thread pages. List-of-thread pages contain discussion topics and subtopics. They provide a list of the threads on the forum site. A long list may be divided into several pages and be connected by page-flipping links in sequence. These pages usually belong to the same sub-boards or sub-topics and share similar content. When some new items are appended to this list, some old items may not be shown in the original page. These old items are not removed, but scrolled down to the following pages.

1.3.4 Post-of-thread Pages. The pages of the leaf nodes (bottom nodes) in the tree are called discussion thread pages or list-of-post pages. Discussion thread pages contain user posts. Users' post records are grouped in threads with the same topic (or title). A long discussion thread may be divided into several pages and connected by page-flipping links. Since the list-of-thread pages and discussion thread/list-of-post pages contain almost all valuable information in forum sites, the technique focuses on the crawling strategy for these two kinds of pages.

### 1.4. High Level System and Process Overview

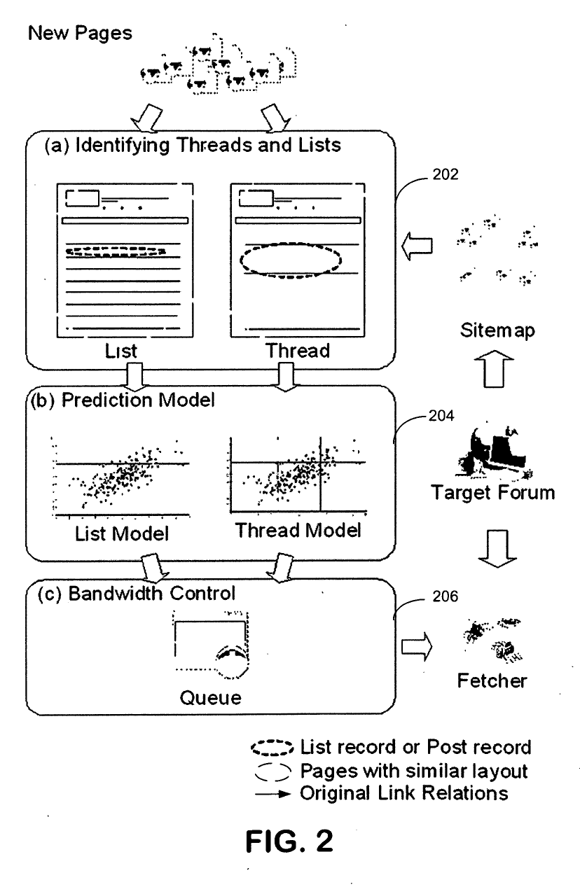

A schematic of the components of the incremental web forum crawling technique is illustrated in FIG. 2. It generally consists of three parts: (I) identifying discussion threads pages and related list-of-thread pages with an automatically generated sitemap of a target forum site(202); (II) predicting the list-of-post and list-of-thread page update frequency based on a regression model (204); and (III) balancing available network bandwidth among the discussion thread and list-of-thread pages, feeding the top ranked number of pages into a queue to crawl (206).

More specifically, in one embodiment, to identify discussion thread pages and list-of-thread pages, the technique first samples a number of pages from a target site. Empirical study has shown that sampling around 2000 pages is sufficient for most forum sites. After that, pages with similar layout are clustered into groups (vertices). Since the data of discussion threads are usually stored in a backend database and rendered using some pre-defined template, discussion thread pages usually have similar layouts and belong to the same group (vertex). It is the same for list-of-thread pages. Given a new page, the technique can map it into a corresponding vertex based on its layout information. The technique can identify the type of a given page by classifying the type of its corresponding vertex. Since a long list or long thread may be divided into several individual pages connected by page-flipping links, the technique concatenates them together by detecting the page-flipping links and treating them as an entire thread list or post list.

As list pages (e.g. list-of thread pages) and discussion thread pages (post pages) have different information, the incremental web forum crawling technique can use separate models for these two kinds of objects. Combined with some global information, such as, for example, the average time interval in sub-board or in forum site, the technique can predict the update frequency for each page and give it an appropriate weight.

Finally, the technique can obtain new discussion threads by revisiting list pages and getting the new posts in existing discussion threads by revisiting post pages. With a fixed bandwidth, the technique can balance the bandwidth between crawling list-of-thread pages and list-of-post pages with an optimized ratio and then select the top ranked K pages with the highest weights to crawl. Details of this will be discussed in the following sections.

### 1.5 Details and Exemplary Embodiments

In this section, the details of the above-described steps of one embodiment of the incremental web forum crawling technique are described.

### 1.5.1 Thread and List Generation

With the category information for discussion thread pages and list-of-thread pages, the technique can avoid repeatedly crawling the content within the same thread or list by scrolling down in following pages. The technique can also estimate the update frequency of such pages. Since discussion thread/list-of-post pages and list-of-thread pages are logical concepts, the technique first needs to identify them from individual pages.

In one working embodiment, the technique first randomly samples about 2000 Web pages and clusters the pages based on their layout similarity into groups (vertices), for example by using a single linkage algorithm. In statistics, single linkage (or “nearest neighbor”) is a method of calculating distances between clusters. In single linkage, the distance between two clusters is computed as the distance between the two closest elements in the two clusters. It can be used in hierarchical clustering algorithm which groups two clusters every time until the distance threshold is achieved.

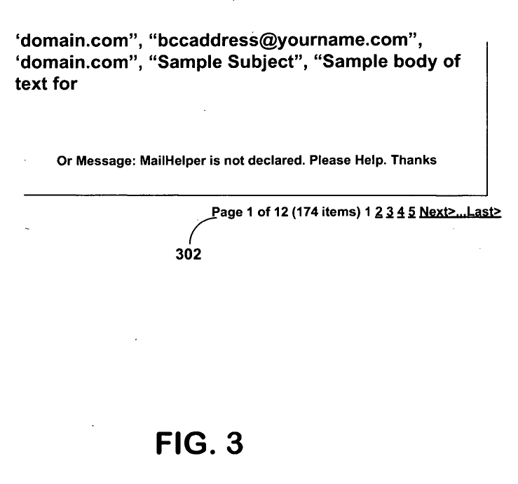

After that, that technique maps each individual page to one of the vertices. The technique strives to concatenate all the individual pages belonging to the same object together. The pages belonging to the same object should share the same template and belong to the same vertex. To link these pages together, the technique links the pages connected by page-flipping links within the same vertex together. A page-flipping link 302 is a kind of loop-back link of a vertex and can be distinguished from other loop-back links as shown in FIG. 3. In one embodiment of the technique, it can be described as the linkage among the multiple post-of-thread pages for a give thread or multiple list-of-thread pages for a given sub-board. Valuable information in forum pages is mostly shown in some repetitive manner both for list-of-thread pages and post pages, as it is essentially data records stored in a database. A repetitive region on a Web page is a block area containing multiple data records in a uniform formation. Thus the technique treats the repetitive region with the largest area ratio as the main block area and segments pages into each record unit. These algorithms have been well studied. With these techniques the incremental web forum crawling technique can identify each data record from the original pages and link all data records belonging to the same object together. Finally, the technique indexes the content of each extracted data record by Locality Sensitive Hashing (LSH). Using an LSH index created by the LSH process, the technique can easily detect whether a post record is duplicated with existing posts and calculate the divergence. For example, in one embodiment, when a crawler crawls a new page, the technique can get the post records in this new page and detect whether they are duplicated with the records of other crawled pages by LSH.

### 1.3.2 Prediction Model

In this section, the prediction model is described. Besides traditional three factors of revisit history, importance, and longevity information of each individual page, the technique employs some other factors when analyzing web forum sites. The technique analyzes some behaviors based on these factors in forum sites, such as the time intervals for the latest several posts, the average time interval between consecutive posts and so on in order to predict discussion thread page and list-of-thread page update frequency. The following sections provide details on the additional factors or features used:

(a) Time intervals for the latest several posts. The post time is recorded by a forum site. The relation between the current post time and the time interval of next post can be determined. In contrast to leveraging the post time directly, the technique leverages the time intervals between each two consecutive post times which represent the recent update frequency of this discussion thread. In one embodiment of the technique, there are three steps to extract the time information. The technique first gets the post time candidates whose content is a short one and contains digit string such as mm-dd-yyyy and dd/mm/yyyy, or some special words such as Monday, Tuesday and January, February. Secondly, the technique aligns HTML elements that contain time information into several groups based on their Document Object Model (DOM) (e.g., an object model for representing HTML documents) path. Finally, since the post records are generated in sequence, the post time is checked to verify that it satisfies a sequence order. With this information the technique can compute the time interval between posts and use this information to predict the next post time. This helps the technique alter noisy time content, such as users' registration time, and get the right information.

The technique can get the thread generation time in a list record similarly. In one working embodiment, the technique only uses the time intervals of the latest six records and represents them as:

Δt₀, Δt₁, Δt₂, Δt₃, Δt₄ (1)

(b) Average time interval in thread or list. The average time interval between data records represents the thread or list update history. Since the time intervals of the latest records (e.g., latest six records in the discussed working embodiment) may be affected by some anomalies, the average time interval helps to smooth the result and minimizes the impact of these anomalies. One can represent the average time interval as:

Δt_{avg} (2)

(c) Average time interval in a forum site. At the beginning of each discussion thread or thread list, information can be used to predict its update frequency. The technique can leverage the average time interval of all discussion threads in current forum site to approximately estimate its possible update frequency. One can represent this as:

Δtₛᵢₜₑ (3)

(d) Thread or list length. The length of a thread (list-of-posts) or length of a thread list can represent its hotness which may lead to users' interests. Thus it may also affect the update frequency of this thread or list. This can be represented as:

len (4)

(e) Current time. There may exist more new post records in the day and fewer posts at night. The update frequency of forum web pages is highly dependent on the current time. One embodiment of the technique can represent the current time in 24 hours via a vector with 24 dimensions. For example, one can represent 3 PM by setting ct₁₅=1 and others to zero.

ctₒ, ct₁, ct₂, . . . ct₂₃ (5)

(f) Average time interval in current hour. Since the update frequency of web pages is highly dependent on current hour, one embodiment of the technique splits one day into 24 hours and leverages the average post number of a forum site in a current time span.

th_{curr} (6)

(g) Current day. More new post records may exist on a working day and fewer posts on a weekend. In one embodiment, the technique can represent the current day via a vector with 7 dimensions. For example, the technique can represent Wednesday by setting cd₃=1 and others to zero.

cd₁, cd₂, cd₃, . . . , cd₇ (7)

(h) Average time interval in current day. Since the update frequency of web pages is highly dependent on the current day, in one embodiment the technique splits one week into 7 days and leverages the average post number of a forum site in the current time span.

td_{curr} (8)

(i) The state of current thread or list. Ideally, one can estimate update frequency of a current thread or list by checking similar threads or lists. To achieve this goal, in one embodiment, the technique first represents the state of a current discussion thread or list via Equation 1 and then clusters the current state into 15 clusters by their Euclidean distances. For each new object, the technique assigns it to one of the states with smallest Euclidean distance. It is possible to represent the 15 states via a vector with 15 dimensions. For example, one can represent state 5 by setting s₅=1 and others to zero.

s₀, s₁, s₂, . . . , s₁₄ (9)

(j) Thread Dead. In one embodiment, the technique initially looks at the analysis of the average thread activity in forum sites. The technique processes all the threads and calculates their activity time by checking the time of the first post and the time of the last post in the thread. It can be shown that thread activity is a typical power law curve. Typically, the activities of more than 40% of threads are no longer than 24 hours and 70% threads are no longer than 3 days. This is the major reason why forum incremental crawling strategy is different with traditional incremental crawling strategies.

Once a thread is created, it may become static when there is no discussion activity for several days. In one embodiment, the technique introduces a dead state indicator to avoid wasting bandwidth. Suppose there is no discussion activity for Δtᵢₙₐ time from the last post. One can compute the standard deviation of the time interval Δt_{sd} by Δt_{sd}=\sqrt{1/(N−1)·Σᵢ₌₁^{N-2}(Δtᵢ−Δt_{avg})²} where N is the number of post records. If Δtᵢₙₐ−Δt_{avg}>α·Δt_{sd}, the technique can set the thread dead indicator ds=1, otherwise, ds=0. This factor is for discussion threads only.

ds (10)

Other factors have linear relationships with the time interval of next post. To combine these factors smoothly and rapidly, the technique can leverage a linear regression model which is a lightweight combination model and efficient for online processing. In equation 11 below, F predicts the discussion thread or thread list page update frequency. X represents all of the features described above, such as Δx₀, Δx₁, Δx₂, Δx₃, . . . Δx₄ represent Δt₀, Δt₁, Δt₂, Δt₃, Δt₄, Δx₅ represents Δt_{avg}, Δx₅ represents Δtₛᵢₜₑ, and so on. N is the number of features. W(Δw₀, Δw₁, Δw₂, Δw₃, . . . w_{N}) are the parameters of this model. In one embodiment, the technique estimates the value for W in training process.

$$F ( x ) = {w}_{0} + {\sum }_{t = 1}^{N} {w}_{0} + {\sum }_{t = 1}^{N} {w}_{i} \cdot {x}_{i} \qquad ( 11 )$$

For each forum site, the technique can train two models for list object (object of the list-of-thread) and post object (object of the list-of-posts) separately. Before the incremental web forum crawling technique begins the real crawling task, the technique can first fetch some sample pages. For each list record or post record from the sampled pages, the technique can generate features x based on the above formulas and predict the time interval y of the next record. The technique collects all of these features and time interval pairs (x,y) as the training samples. By setting x₀=1, the technique can get the corresponding W by Equation 12.

W=(X^{T}·X)⁻¹·X^{T}·Y (12)

In the crawling process, the technique estimates the information ΔI of each post or list object by ΔI=(CT−LT)/F(x), where CT is the current time and LT is the last revisit time. The technique uses this weight to schedule the crawling. The two models will also be updated during the crawling process. For example, in one embodiment the model is updated by equation (12) every month.

### 1.3.3 Bandwidth Control

As discussed in previous sections, the technique considers the tradeoff between discovering new pages and keeping existing pages fresh. The technique introduces a hyper bandwidth control strategy to balance the bandwidth between the list objects and the post objects. The ratio between list object and post object can be defined as:

$$ratioα \frac{{N}_{List}}{{N}_{Post}} \qquad ( 13 )$$

where given a time period Δt, N_{List} is the number of new discussion threads appearing in list object within time Δt and N_{Post} is the number of new posts appear in post object within time Δt. The technique uses the average ratio in history to balance the bandwidth between two objects.

The overview and details of various implementations of the incremental web forum crawling technique having been discussed, the next sections provide exemplary embodiments of processes and an architecture for employing the technique.

### 1.4 Exemplary Processes Employed by the Incremental Forum Web Crawling Technique.

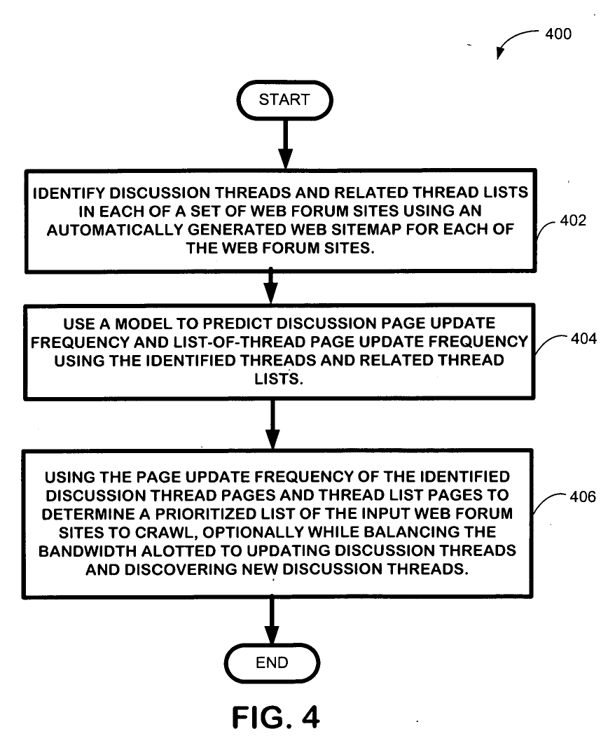

An exemplary process 400 employing the incremental web forum crawling technique is shown in FIG. 4. As shown in FIG. 4, block 402, discussion threads and related thread lists (list-of-threads) are identified in each of a set of web forum sites using an automatically generated web sitemap for each target forum website. In one embodiment, thread identification is done be grouping pages according to their page layout similarities and using page flipping links to concatenate the pages into one long discussion thread or list-of-threads. This web sitemaps can be generated in one of any conventional ways of reconstructing a sitemap from website data. Then, as shown in block 404, a model for predicting discussion thread page update frequency and list-of-thread page update frequency is used to predict the discussion page update and list-of-thread page update frequency using the identified threads and related lists. The page update frequency of the identified discussion threads and thread lists is then used to output a prioritized list of web forum sites to crawl, as shown in block 406. This can be done while balancing the bandwidth allotted to finding updates to existing discussion threads and finding new discussion threads.

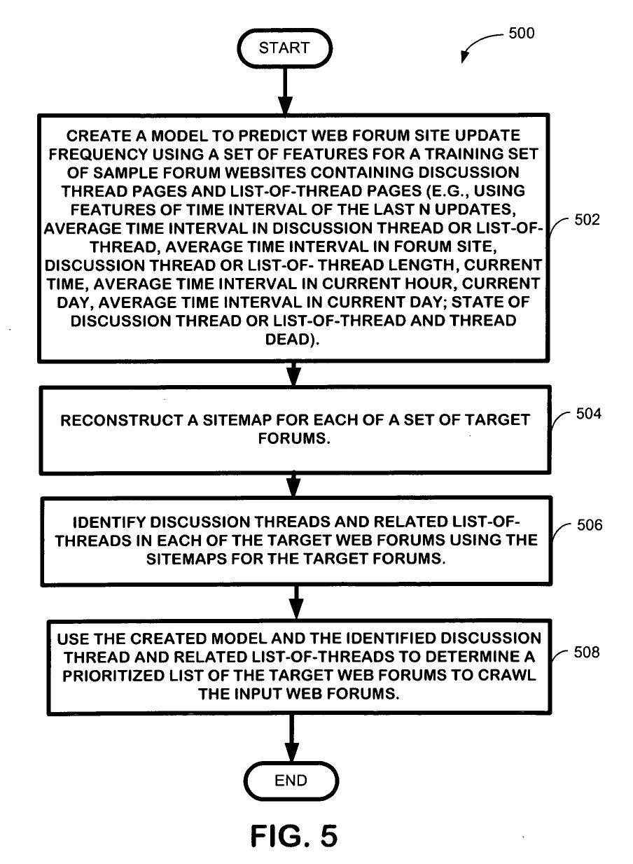

FIG. 5 depicts another exemplary process 500 employing one embodiment of the incremental web forum crawling technique. As shown in block 502, a model for predicting web forum site update frequency is created using a set of features for a training set of sample forum websites containing discussion thread pages and list-of-thread pages. The features can include the time interval of the latest page updates, the average time interval in a discussion thread or a list-of-threads, average time interval in the forum site, discussion thread or list-of-thread length, current time, average time interval in the current hour, current day, average time interval in the current day, the state of the discussion thread or list-of-threads, and whether the thread is dead or not. A sitemap for each of a set of input target forums is reconstructed, as shown in block 504. Discussion threads and related-list-of threads in each of the target web forums are then identified using the sitemaps of the target forums (block 506). The created model and the identified discussion threads and related list-of-threads are then used to determine a prioritized list of web forum sites to crawl, optionally while balancing network bandwidth amount between discussion thread and list-of-thread types of forum web pages (block 508).

### 1.5 Exemplary Architecture Employing the Incremental Forum Web Crawling Technique.

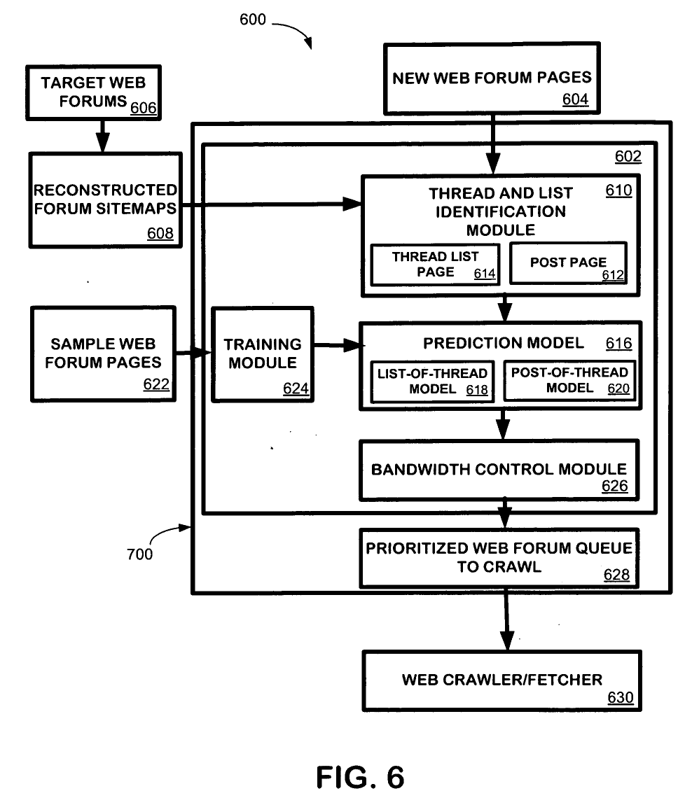

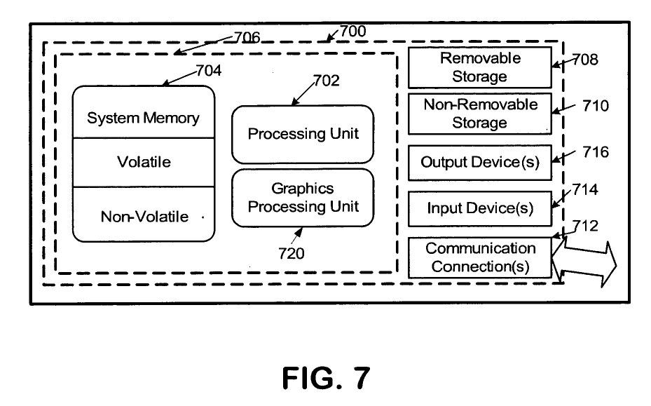

FIG. 6, provides one exemplary architecture 600 in which one embodiment of the incremental web forum crawling technique can be practiced. As shown in FIG. 6, block 602, the architecture 600 employs a forum web crawling ranking module 602, which typically resides on a general computing device 700 such as will be discussed in greater detail with respect to FIG. 7. The forum web crawling ranking module 602 has a post-of-thread and list-of-thread identification module 610 which identifies post-of-thread pages 612 and list-of-thread pages 614, respectively, based on a reconstructed forum sitemap 608 which is based on a given target web forum 606. The identified post pages 612 and list-of-thread pages 614 are used by a prediction model 610 which includes a post-of-thread model component 620 and a list-of-thread model 618 component. The prediction model 616 is used to predict the update frequency of the list-of-thread and post-of-thread pages. The prediction model 616 is trained using a set of sample web forum pages 622 and a training module 624. The output of the prediction model is input into a bandwidth control module 626 which balances the available bandwidth between the list objects (e.g., new threads) and post objects (e.g., new posts) over a given time increment to output a prioritized web forum queue 628 for a web crawler or fetcher to crawl or re-crawl in order to find new threads and update existing posts.

### 2.0 The Computing Environment

The incremental web forum crawling technique is designed to operate in a computing environment. The following description is intended to provide a brief, general description of a suitable computing environment in which the incremental web forum crawling technique can be implemented. The technique is operational with numerous general purpose or special purpose computing system environments or configurations. Examples of well known computing systems, environments, and/or configurations that may be suitable include, but are not limited to, personal computers, server computers, hand-held or laptop devices (for example, media players, notebook computers, cellular phones, personal data assistants, voice recorders), multiprocessor systems, microprocessor-based systems, set top boxes, programmable consumer electronics, network PCs, minicomputers, mainframe computers, distributed computing environments that include any of the above systems or devices, and the like.

FIG. 7 illustrates an example of a suitable computing system environment. The computing system environment is only one example of a suitable computing environment and is not intended to suggest any limitation as to the scope of use or functionality of the present technique. Neither should the computing environment be interpreted as having any dependency or requirement relating to any one or combination of components illustrated in the exemplary operating environment. With reference to FIG. 7, an exemplary system for implementing the incremental web forum crawling technique includes a computing device, such as computing device 700. In its most basic configuration, computing device 700 typically includes at least one processing unit 702 and memory 704. Depending on the exact configuration and type of computing device, memory 704 may be volatile (such as RAM), non-volatile (such as ROM, flash memory, etc.) or some combination of the two. This most basic configuration is illustrated in FIG. 7 by dashed line 706. Additionally, device 700 may also have additional features/functionality. For example, device 700 may also include additional storage (removable and/or non-removable) including, but not limited to, magnetic or optical disks or tape. Such additional storage is illustrated in FIG. 7 by removable storage 708 and non-removable storage 710. Computer storage media includes volatile and nonvolatile, removable and non-removable media implemented in any method or technology for storage of information such as computer readable instructions, data structures, program modules or other data. Memory 704, removable storage 708 and non-removable storage 710 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 700. Any such computer storage media may be part of device 700.

Device 700 also contains communications connection(s) 712 that allow the device to communicate with other devices and networks. Communications connection(s) 712 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media such as acoustic, RF, infrared and other wireless media. The term computer readable media as used herein includes both storage media and communication media.

Device 700 may have various input device(s) 714 such as a display, a keyboard, mouse, pen, camera, touch input device, and so on. Output device(s) 716 such as speakers, a printer, and so on may also be included. All of these devices are well known in the art and need not be discussed at length here.

The incremental web forum crawling technique may be described in the general context of computer-executable instructions, such as program modules, being executed by a computing device. Generally, program modules include routines, programs, objects, components, data structures, and so on, that perform particular tasks or implement particular abstract data types. The incremental web forum crawling technique may be practiced in distributed computing environments where tasks are performed by remote processing devices that are linked through a communications network. In a distributed computing environment, program modules may be located in both local and remote computer storage media including memory storage devices.

It should also be noted that any or all of the aforementioned alternate embodiments described herein may be used in any combination desired to form additional hybrid embodiments. Although the subject matter has been described in language specific to structural features and/or methodological acts, it is to be understood that the subject matter defined in the appended claims is not necessarily limited to the specific features or acts described above. The specific features and acts described above are disclosed as example forms of implementing the claims.

Wherefore, what is claimed is:

1. A computer-implemented process for crawling web forums, comprising:
identifying discussion threads and related thread lists in each of a set of web forum sites;
using a model for predicting discussion thread page update frequency and list-of-thread page update frequency to predict discussion page update and list-of-thread page update frequency using the identified discussion threads and related thread lists; and
using the page update frequency of the identified discussion threads and thread lists to output a prioritized list of web forum sites to crawl.

2. The computer-implemented process of claim 1 further comprising balancing network bandwidth amount between discussion pages and list-of-thread pages while determining the prioritized list of web forum sites to crawl.

3. The computer-implemented process of claim 2 wherein the balancing network bandwidth comprises applying a ratio of a number of new discussion threads appearing to a number of the new posts appearing over a given time increment.

4. The computer-implemented process of claim 1 comprising identifying discussion threads and related thread lists using an automatically generated web sitemap for each of the web forum sites created by grouping pages with similar page layouts.

5. The computer-implemented process of claim 1 further comprising creating the model for predicting page update frequency, comprising:
fetching a set of sample forum web pages;
for each list record or post record from the sample forum pages, generating a set of features and predicting the time interval of the next record using the generated set of features;
using the generated features and associated predicted time interval as training samples to train the model.

6. The computer-implemented process of claim 5 further comprising weighting each feature time interval pair to determine a schedule to be used to determine when to crawl a forum website.

7. The computer-implemented process of claim 1 wherein the model is based on a feature comprising time intervals of a given number of latest post records.

8. The computer-implemented process of claim 1 wherein the model is based on a feature comprising average time interval in a forum website.

9. The computer-implemented process of claim 1 wherein the model is based on a feature comprising discussion thread length or thread list length.

10. The computer-implemented process of claim 1 wherein the model is based on a feature comprising current time and current day.

11. The computer-implemented process of claim 1 wherein the model is based on a feature comprising average time interval between updates in a current hour.

12. The computer-implemented process of claim 1 wherein the model is based on a feature comprising average time interval between updates in a current day.

13. The computer-implemented process of claim 1 wherein the model is based on a feature comprising state of the current discussion thread or list-of-thread.

14. The computer-implemented process of claim 1 wherein the model is based on a feature comprising thread dead status.

15. A system for web forum crawling, comprising:
a general purpose computing device;
a computer program comprising program modules executable by the general purpose computing device, wherein the computing device is directed by the program modules of the computer program to,
identify discussion threads and list-of-threads for an input set of web forum sites;
predict a discussion thread page update frequency and a list-of-thread page update frequency using the identified discussion threads and list-of-threads and a model for predicting discussion thread page update frequency and list-of-thread page update frequency; and
create a prioritized queue of the input web forum sites to crawl using the discussion thread update frequency and list-of-thread page update frequency while balancing the bandwidth assigned to finding new discussion threads and the bandwidth assigned to finding new posts.

16. The system of claim 15, further comprising extracting data from repetitive regions of the discussion thread pages and the list-of-thread pages in order to determine page update frequency.

17. The system of claim 15 further comprising using a reconstructed forum website to identify the discussion threads and list-of-threads for the input set of web forum pages.

18. The system of claim 15 wherein discussion thread page and list-of-thread pages are concatenated from more than one page using page-flipping links.

19. The system of claim 15 wherein the prediction model further comprises a post-of-thread model component and a list-of-thread model component.

20. A computer-implemented process for crawling web forums, comprising:
creating a model for predicting web forum site update frequency using a set of features for a training set of sample forum websites containing discussion thread pages and list-of-thread pages;
reconstructing a web sitemap for each of a set of input target web forums;
identifying discussion threads and related-list-of threads in each of the target web forums using the sitemaps of the target forums;
using the created model and the identified discussion threads and related list-of-threads of the target forums to determine a prioritized list of web forum sites to crawl.
